(19) United States
(12) Patent Application Publication
(10) Pub. No.: US 2011/0191681 A1
(43) Pub. Date: Aug. 4, 2011

(54) Systems and Methods for Human Intelligence Personal Assistance

(76) Inventor: Dean Stark, Toronto (CA)

(21) Appl. No.: 13/019,974

(22) Filed: Feb. 2, 2011

Related U.S. Application Data
(60) Provisional application No. 61/300,790, filed on Feb. 2, 2010.
(60) Provisional application No. 61/300,550, filed on Feb. 2, 2010.

(51) Int. Cl. G06F 3/01

(52) U.S. Cl. 715/716

(57) ABSTRACT

A human intelligence personal assistance system and method is disclosed. A user interacts with an audio and video image of a person. Inputs from the user request performance of one or more tasks including passive requests activated by mere motion detection. Thus the user may actively request tasks such as email review or passively trigger tasks such as sales assistance. Depending upon the complexity of the task, either a human operator or a computer may assist the user. The audio and video image communicates with the user in synchronization with downloaded results.

### CROSS-REFERENCE TO RELATED APPLICATIONS

The present application is a non-provisional application which claims the benefit of provisional application U.S. 61/300,790 entitled “Systems and Methods for Human Intelligence Personal Assistance” filed Feb. 2, 2010 (Attorney Docket No. 124918-200100/US) which is hereby incorporated by reference in its entirety. The present application also claims the benefit of provisional application U.S. 61/300,550 entitled “Systems and Method for Interface with Multiple Resources” filed Feb. 2, 2010 (Attorney Docket No. HIPA) which is hereby incorporated by reference in its entirety.

### COPYRIGHT NOTICE AND PERMISSION

A portion of the disclosure of this patent document contains material which is subject to copyright protection. The copyright owner has no objection to the facsimile reproduction by anyone of the patent document or the patent disclosure, as it appears in the patent and trademark office patent file or records, but otherwise reserves all copyright rights whatsoever.

### FIELD OF INVENTION

The present invention relates to the field of interface of a human to a computerized audio and video image.

### BRIEF SUMMARY OF THE INVENTION

Each day most of us spend a significant portion of our day performing a significant number of repetitive tasks—A Human Intelligence Personal Assistance (HIPA) will make those daily tasks effortless—HIPA can be responsible for making your life better.

The HIPA may be a direct VoIP (Voice over IP) or video link between the end user and a call center in Asia, for example. All registered users will enjoy a high quality HIPA experience regardless of complexity of the task requested. The user will seamlessly be escalated to another operator or multiple operators with more expertise if required in various specialties from reviewing and responding to a user's emails, to assisting an user in travel plans or helping a user's child with his or her grade 6 homework.

Anytime the HIPA detects any level of frustration or dissatisfaction from the user in the most minor way (i.e. from the tone of your voice, language) the HIPA operator will seamlessly escalate your connection or conversation to a supervisor specialist in the required area. During this transfer, the user will have no real knowledge of the transfer as the user will still be talking to the same voice and will be viewing the same 3D human image of his or her HIPA.

These and other objects and advantages of the present invention will become clear to those skilled in the art in view of the description of the best presently known mode of carrying out the invention and the industrial applicability of the preferred embodiment as described herein.

### BRIEF DESCRIPTION OF THE DRAWINGS

The embodiments are illustrated by way of example and not limitation in the figures of the accompanying drawings in which like references indicate similar elements.

FIG. 1 shows a human intelligence personal assistance system according to one embodiment.

FIG. 2 shows an example user terminal used for a human intelligence personal assistance system according to one embodiment.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein are merely provided for ease of reference, and shall not be interpreted in any way to limit this disclosure or the following claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

### Unlimited HIPA Bandwidth

In one embodiment, a user's HIPA can simultaneously review a user's unopened voice mail messages, document them into a summary email by caller, priority and subject, review and summarize important emails from people who have been listed in a user's profile (provide previously and which can be modified dynamically) as being important people. A user's HIPA personal profile and its dynamic workload scalability feature allows a user to determine how fast the results are generated. The results can be provided as fast as the user can communicate with his or her interface HIPA. One HIPA can work independently on a simple task, but once the task becomes time intensive or several tasks are required to be completed, the task(s) will be assigned dynamically to multiple HIPAs providing virtually unlimited bandwidth. This will provide the user the ability to assign a series of simple to very complex tasks that can be worked on simultaneously, depending on the complexity, specialty, and the time required to complete the required tasks. Similar to a multiple processor computer, the other processors (i.e. HIPAs) start up automatically as the workload or number of tasks required begin to increase and more time consuming or complex tasks are broken into pieces. Thus, each of these pieces can be worked on by multiple operators in Asia, for example, and the results are then seamlessly funneled back to a single HIPA interface as easily as they were broken down into separate components in the first place, in order to execute them in the most efficient manner. All of this is done while the user continues to communicate to what appears to be one person, when in fact multiple HIPAs are working on a task. Multi-HIPA task processing and the user profile/preferences are the key to the success of the customer experience. The customers profile allows a user's HIPA to dynamically expand its band-width of capabilities well beyond any other assistant type service offered on the planet. The cost for service should be based on the number of combined operators' seconds, regardless of how many different operators are involved to complete the task. Almost all tasks may be broken into pieces to reduce the amount of time for all tasks to be completed. One user using one HIPA could involve as many as 1 to 30+ people depending on the required tasks. The process of determining how tasks should be spread over multiple operators could be on one of several variables, e.g.: (1) The requirements of the customer; (2) The number of tasks; and (3) The specialization of the tasks (i.e. travel research, review emails, print reports, and so on).

The HIPA experience may use software to dynamically parse user requests made by customers to their HIPA into the most efficient components that can be seamlessly directed to individual operators in Asia, for example, who may process the broken down parts/components and then the software will re-assemble/recompile the pieces into a format that will complete the initial task request by the user (in a similar fashion to how a computer processor interprets software coding and separates portions of the coding to various specialized parts of the processor that specialize in for example memory, video, i/o processor management and multi-threading management).

### Concepts

### 1. Retail Store Window Display

In one embodiment, a customer may be walking along Bloor Street in the evening after a store has closed, and notices an interactive video of a woman trying on a new jacket from a reputable manufacturer of fashion apparel. As the Customer walks by he/she is detected by the sensor and then, a beautifully dressed HIPA model faces the customer and says “it's nice to see you this evening” (the script changes by time of day). “Can I show you our new brilliant Spring scarf collection, starting at $99?” A photo-realistic display of the new scarves stream down the side of the HIPA display in 3D. The model continues to try on one of the scarves. She then asks the potential customer if they would like to see her wearing another one of the scarves being displayed. If the user says yes, she would then ask which one and each one would be highlighted for a moment in sequence. The potential customer says “The 3rd one or the green one with blue designs” and the model will then seamlessly put it on. As the HIPA puts on the scarf she will begin describing the product and romancing the value of owning a scarf from this line of fashion apparel and how it can accent any ensemble. She will then ask the customer if they would like to purchase a scarf from her. And if they say yes, she will then ask if they would like to have it delivered directly to their home or place of business tomorrow. Then she would simply ask that they tell her their name and provide her with payment details by simply holding up their credit card to a tiny camera mounted on the window The HIPA would be able to quickly zoom in on a still image of the credit card and record the card number and depending on the credit card the customer may be asked to display the backside as well. If the customer says no (to her initial question about the scarf she will then ask the customer if they would like to view the latest hand bags, or any other category that she will list on the window screen and continue to take them on a 3D tour of the store highlighting various departments and key products.

### 2. Virtual Store Directory

In another embodiment, a customer will enter a retail store and the customer will be greeted by a HIPA featuring the latest advertised outfit and possibly in a real life setting. The HIPA will then ask the customer if they are aware of some of the current specials in the various departments at store X and if they would be interested in further details or assistance or with anything else including:

a) The location of a specific department

b) The cost of a particular product whereby the customer provides a verbal description of the item and the HIPA can confirm it by displaying an image of the product. The HiPA can also provide stock availability and details of items that were advertised. The HIPA will also have the ability to sell the items directly to the customer using the best sales techniques know to retail that will be pre-scripted by an retail/publicity specialty agency.

c) Assistance with selecting a gift for friend.

The HIPA will be well trained on every aspect of the department store and have full access to inventory, product location, supplier product specifications and features of every item in inventory, video images and in many cases 3D renderings of many retail items. Most importantly, the HIPA will have a vast library of pre-scripted exceptional selling points and phrases regarding each item shown with a very targeted method of closing the sale. The HIPA sales experience will be exceptional, scripted by the world's best retail consultants. Customers will feel as though they are serviced rather than sold.

The HIPA will also ask the customer if they would like assistance in finding the location of a specific product(s) or department(s). The HIPA will also ask the customer if they would like a copy of the map highlighting their specific area(s) of interest and/or any specific advertisement or specific product details and/or a very clean simple 3D map clearly indicating the location of their departments or items of interest that are in relation to their current location. They will be asked by the HIPA their name and they will be asked to pick-up their personalized map highlighting the customer's area of interest and the map could also include featured products in those departments. They could also include specific items or gift selections provide by the HIPA.

The HIPA will also offer the customer a continued HIPA experience as they leave the store directory area by having them dial a phone number spoken by and displayed by the HIPA on the screen or the HIPA can call them to continue the conversation if the customer provides her with their phone number as many cell phone users do not pay for incoming minutes. An incentive could be created by the Department Store to encourage customers to use HIPA by advertising that the HIPA will offer users exclusive offers randomly in various departments upon using the service throughout the day. This will allow the customer to seamlessly continue a conversation throughout the entire store with the HIPAs, for example through a mobile phone, PDA or other such device, or through screens equipped with HIPAs, VoIP capabilities, and sensors and/or microphones that are located throughout the store. The HIPAs will offer the customers guidance and product information on any item or department by having the customer identify an item by brand and description and giving the HIPAs access to unlimited product information and selling points from the Department Store and the Manufacturer. Most importantly, the HIPA will have the world's best pre-canned closing scripts created by the world's best retail sales experts and modified and approved by each manufacturer.

Using HIPA will be similar to shopping with the world's best sales associate. This does not mean that the customer will be oversold. It means that the customer will have the opportunity to be guided by a person who can offer more information relating to the needs of the customer and make the experience more efficient and exciting. For example, when the customer is looking at Diesel Jeans they might be told that they are still made completely in Italy and are still completely hand-sewn and washed with 3″ rocks.

### 3. Virtual Check-Out

In another embodiment, HIPA users will now have the ability to process payment and check-out themselves anytime or anywhere when they want to purchase anything or have it delivered. Today, retail has become synonymous with low service levels and customers find it very difficult to find any assistance even when they just require someone to take their money. Anywhere in the store (utilizing a mobile phone or PDA or other such device) or in a multitude of designated Virtual HIPA checkout Stations depending on the preference of the specific store, select customers would have the ability to check themselves out, without having to go through a physical cashier. A HIPA can be used to efficiently purchase an item, rather than searching for a cash desk that is unattended or finding one with a demanding, time consuming customer or one where the sales clerk is slower than slow, or where the line is so long for a cashier that the customer can't wait and simply puts down the item that they intended to purchase and walks out of the store.

A customer service orientated retail/department store will offer virtual HIPA checkout services to their most valued customers providing them the ability for them to perform Virtual Check-outs/payments as a preferred service, enhancing the overall retail experience. They would simply identify the product they want to pay for and/or walk into a designated virtual checkout area that would have one or a series of HIPA check-out displays. These stations would also be well covered by video cameras and the HIPA would also be asking the consumer to identify their location and to identify all paid and unpaid product(s) they have in their possession. The HIPA can also visually judge the customer in conjunction with the customers existing profile. A detailed video record of the entire transaction can be recorded and become part of a customer profile. The HIPA operator (an actual human being that controls the HIPA on the other end who would also be trained specifically in check-out procedures) that is specified by the specific retailer would also have the ability to call for retail personnel to assist if required as well. The HIPA operator might also claim a system problem exists if they do not feel confident that the customer is conducting themselves in accordance with the required specified retail store guidelines. This avoids any type of embarrassment for the customer and the retailer. The customer might be allowed by the Department Store to check out anywhere in any aisle (via mobile phone or PDA or any such device, or through the above-described virtual HIPA stations located throughout the store) simply by verbally describing the product or reading the Department Store SKU number or the UPC number. The customer will also have the ability to inquire about other colours and stock availability and could also arrange to have the product delivered. HIPA would also have the ability to compare products and make suggestions based on stock availability. And of course HIPA will have its vast product knowledge product library and selling skills at its disposal at all times.

### 4. Your HIPA at Home & Work

In another embodiment, the HIPA can assist a user in a variety of different daily tasks. A user's daily life will never be the same again without a HIPA. The user's day would start by receiving a pre-arranged text message, email, telephone call, or whisper from a life-like HIPA image of an attractive male or female HIPA image at the user's bedside when they wake-up. The HIPA image will ask the user for directions enabling the HIPA to fulfill all of items that a user would like the HIPA to do today and throughout the day, week etc., as well as what a user's spouse and children also require from the user. The user will have the ability to interrupt, ignore or have the HIPA focus on composing or replying to emails, text messages, or placing telephone calls to anyone while the user is still lying in bed contemplating the day ahead without lifting a finger.

The user might be thinking of going away for the weekend which in that case, the user may ask the HIPA to search Expedia and other sites for great deals leaving this Friday after 7 pm, summarize them and print them out on the printer in the user's home office. The user might also ask the HIPA to arrange to have three of the four DVD's to be described to the HIPA by the user and also be delivered next Friday using the account of a DVD delivery service the user may use. The user may also have the HIPA find out the price of a new scarf seen in a magazine that the user may want to purchase for the user's spouse's birthday next week and the user also may want to be reminded on a daily basis of that event by some discrete reminder each day.

The user can also have a HIPA conference with 2 or 3 people by phone and then conference the user in so the user does not have to waste his or her personal time with voice mails. When the HIPA leaves a message for someone to call a user back, the HIPA will leave a Google Voice number that will be answered by the HiPA on the user's behalf and the HIPA will ask the user's permission to conference the other callers in to the user before informing the caller of the user's availability. As the user makes each additional request from a HIPA, and depending upon the request, the user's HIPA may assign the requests to multiple HIPAs, simultaneously allowing each request to be executed by a specialist, for instance, a request may be executed by the appropriate specialist in an area near the user. In certain situations, the task requested may take some time to execute and it may be necessary for the HIPA to request some time for the response. HIPA will alert the user by their default alert method when they have resolved the task, unless told otherwise. The HIPA may be asked by the user to call them, send them a text message or email them and repeat the reminders in a time interval provided by the user, for example.

Everything above can be achieved without lifting a finger, while the user is relaxing on the pillow in the morning while glancing to the left to see a HIPA image at his or her side planning, making the planning for the user's day ahead a breeze.

### 5. HIPA Mobile

In another embodiment, the user's HIPA will also be available through the day via the user's cell phone, PDA, smart phone or other such device. The user's caller ID will be the link to the user's personal HIPA profile just as a user's IP User ID and password will be at the user's home and office. MSS mobile users may also have the ability to view their HIPA through their phones.

### 6. HIPA Translation

In another embodiment and in the context of non-English-speaking countries, local HIPA operators in a non-English-speaking country may be hired to simply listen to customers and translate the voice of the customer from English into the text of the country's local language. Voice-to-text software may also be enabled to assist the HIPA operators depending on the sound quality and the clarity and quality of the voice-to-text translation. The text result will be streamed to Asia, for example, and HIPA operators in Asian would translate the text into English and translate the text to speech, and it would then be handled in the same manner as an English consumer would be handled.

### 7. Further Detailed Applications

a) Students—In another embodiment, a parent might want their child to spend 15 minutes a day having their child review their homework or get assistance in a specific subject which can be specified in a text box in the HIPA interface. The HIPA will be trained and experienced on the lesson being reviewed before each session. The HIPA will be able to report back to the parent when requested on the progress of the child.

b) For the User, User's Kids and User's Elderly Parents—In another embodiment, all users will be able to view the HIPA's computer screen in Asia, for example, and the HIPA operators will allow the user to guide or perform any task they desire and show the consumer's email, full profile, web browser, assist in setting up a server, touching up an image in a photo-editing program, writing a VB application or any other software application, and the consumer can direct the HIPA to perform any of the above or any other task by voice. For instance, a user can ask the HIPA to buy some music online, to write a book report, to create a spreadsheet chart using data from their email, play a movie, and so on and so forth. In the case of music or movies, the user will also hear the audio stream of the relevant media as well as the voice of the HIPA.

c) Businesses—In another embodiment, businesses may have a HIPA on their reception or security desk instead of a traditional receptionist. The HIPA will also be able to answer incoming calls and transfer them within an organization using VoIP.

d) Web—In another embodiment, businesses might purchase a license to have their own branded HIPA on their own website to sell products using varying ethnicities, local languages and dialects that correspond to an online user's or consumer's location. These businesses might also license from HIPA a “Corp profile” which is a data profile allowing a company to tailor the user experience using authorized elements of the user's HIPA profile.

e) VNC—In another embodiment, the user will have the ability to either get any level of service or assistance on any of his home or office computers or smart cell phones using Virtual Network Computing (VNC). All computers and all UNIX-based phones and Windows-based phones (e.g. Blackberry, iPhone, Windows Mobile and Google's Droid OS all work with VNC) work easily with VNC. VNC may be similar to Microsoft's Remote Desktop but may be free and/or open-sourced. This VNC capability may allow a HIPA customer to receive assistance from their HIPA to add contact information to their wireless phones, add movies, install applications, update firmware or fix simple or complex phone issues. VNC allows a user to assume control of another computer across a local network or the Internet. A particularly good choice for mobile users, VNC includes a Java client that enables a user to access a remote computer via any browser without installing any software. At present, there are ready-made versions for Windows, UNIX, Linux, and Solaris. VNC be may performed with a HIPA without slowdown over a LAN connection and may also not consume much memory. In order to operate VNC over a slow connection, a user may need to reduce colors, remove the desktop wallpaper, or have only one active window on their phones or mobile devices that utilize VNC. The VNC interface has no means of handling numerous connections, though the user may save them as usual shortcuts. The VNC program can be made to run as a service process, allowing the user to connect to a machine that has nobody logged onto it. The installation files are small enough that the user may save them onto a floppy. Some versions of VNC may be free, and VNC may be suitable both for home and business use, especially since VNC may be open-source, fully documented, and uses a platform-independent protocol that enables the user to remotely operate on a variety of platforms.

f) Screen Viewing—In another embodiment, users will also have the ability to view the HIPA's entire screen or a portion of the HIPA's screen.

g) Specialized Training—In another embodiment, the HIPA would be able to provide specialized training to the user in everything from cooking to playing certain sports to any of a number of different disciplines.

h) Supervising Children—In another embodiment, a user's HIPA may be assigned the task of watching the user's children in their rooms or playing together and warn the user (the parent) if the children start fighting or doing anything that is or is not permitted by the parent specified in their profile. All the parent has to do is enable a wireless or wired camera, which may also be a series of cameras.

i) Monitoring Audio—In another embodiment, audio can also be monitored in conjunction with video.

j) Recording and Archiving Audio and Video—In another embodiment, both the audio and video can be recorded and archived by the HIPA.

k) Real-time Monitoring and Recording—In another embodiment, a security company, retail store, parent, or a very caring pet owner might want to have one or a series of video/audio cameras monitored or recorded by their HIPA and monitored in real time or recorded. Motion-detection software may also be added as an option that can alert the HIPA of activity to be scrutinized and for further instructions to be followed such as, for example, calling the parents who are out to dinner that the kids are fighting and the baby-sitter is sleeping or ignoring the children.

l) Streaming Video Via Mobile Device: In another embodiment, video may also be streamed via cell phone, smart phone, PDA or any other such device to any location and monitored.

m) Camera Uses—In another embodiment, a car buff, for example, may want to aim a camera though his window at his car on the street and have the HIPA notify him if someone touches his car.

n) Television/Movie Guide—In another embodiment, a user might want his HIPA to be his Television/Movie guide to the world. For instance, the HIPA would offer pay-per-view services available in the U.S. and world-wide. The HIPA central office would stream video/audio in a similar format to how one views a video/audio feed from a home personal video recorder (PVR) to a remote laptop or mobile device or cell phone. The video/audio content may also be viewed via VNC or specialized streaming software.

o) Worldwide Streaming—In another embodiment, the HIPA provider in Asia, for example, may enable a user to view a video stream of any movie or television program worldwide.

p) Sharing and Controlling Software Programs—In another embodiment, the HIPA may offer a user the ability to share and control Virtual Computers in Asia, for example, that contain the most popular software programs. This can be easily done by installing licensed software into VM's (Virtual Machines) that are owned and operated by the HIPA provider and that can also be shared with the HIPA, allowing the user to have unlimited use of particular software programs when connected to the HIPA.

q) Assistance via VNC or MS Remote Desktop—In another embodiment, the user can allow the HIPA to access his or her computer by VNC or MS Remote Desktop, which then enables the HIPA to monitor or assist the user with any activity on the computer. For example, a HIPA may be asked to help senior computer programmers who are having a problem debugging an application that must be completed by a certain time. In this scenario, specialists in a particular type of computer language and/or application type may be called upon to assist the senior computer programmers until the problem is resolved.

r) Calling Upon Virtual Guests—In another embodiment, virtual guest could be called upon by the HIPA provider to assist either the HIPA provider and/or the customer if the customer requires very specialized assistance. For example, if the customer required assistance with a computer using an obsolete or obscure IBM OS level and no-one within the HIPA provider can help, the HIPA may then invite known people with special talents, such as a retired IBM employee who is very familiar with the OS level that the customer of HIPA requires assistance on. The HIPA will then invite in the retired IBM employee to assist using any online meeting or web conferencing software.

s) Sharing Music—In another embodiment, music can also be enjoyed by sharing out a licensed VM controlled by the HIPA featuring a host of popular music selections. Some of these can be compiled by well-known DJ's for events and can be licensed by the HIPA, and organized as well as rented out to a HIPA customer.

t) Facilitating Business Communications—In another embodiment, users may use HIPA to facilitate business communications across the world. For example, if a HIPA customer in New York might be developing a new design concept and he or she wanted to view the display windows on a specific street in Milan, he or she could ask their HIPA to arrange for a HIPA employee/affiliate to visit the required location at a pre-arranged time using a streaming video/audio cell phone enabling the customer to communicate exactly what they want to see in near or real-time in any city in the world. The HIPA organization would hire people in each city when required on a contract basis to perform any legal task through the HIPA. Potential contractors would be hired by a specialized group of people at the HIPA organization that would advertise for such people using vehicles such as classifieds web-pages and job-hunting websites. Most contractors would be sent a special video cell phone to use while performing their tasks(s) in order to allow the customer to direct or steer the local contractor in the task required and view the image that the HIPA customer wants. For example, an automobile designer might ask his HIPA to have a contractor attend the Annual Detroit Auto Show and provide a phone video/audio signal to the end customer. The customer will direct the HIPA who will in effect direct the contractor with very specific instructions as to which aisles to walk, where to stop and what to say. The customer might also ask the contractor to select specific documents and take them directly to a Fedex or UPS location to mail them. These documents could either be sent to the HIPA or directly to the end customer. Retail Store businesses might also have their HIPAs walk the aisles of new entrants or competitors world-wide using the unique control and data-feed of the simple, consistent HIPA interface. A company's head office might also want to have a HIPA hire someone to inspect their own facilities via cell phone or video phone or some other video communication means.

u) Other Business Applications—In another embodiment, a HIPA can be used at, for example, trade shows or cars shows, or to tour competitor's stores or to view new buildings to build new branches of stores, and so on and so forth.

### DESCRIPTION OF THE FIGURES

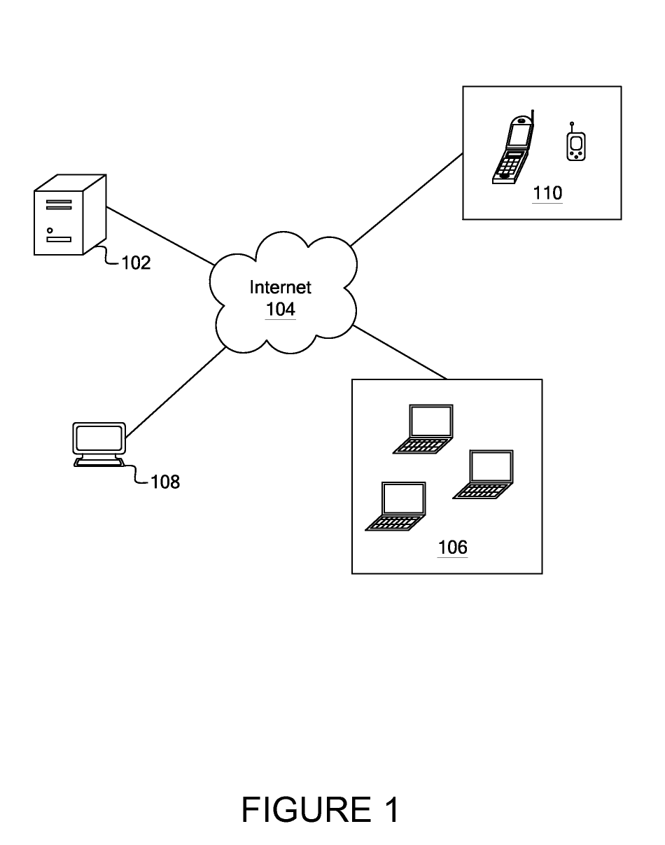

FIG. 1 shows a human intelligence personal assistance system according to one embodiment. Specifically, FIG. 1 illustrates a server connected to at least one terminal through a network, wherein the server stores software according to an embodiment of the present disclosure. Software or program code directed to functions and data structures which can be used in, for example, a human intelligence personal assistant (HIPA), may be tied to remote server 102. Remote server 102 is connected to the Internet 104, and the Internet 104 is in turn connected to at least one computer 108 by a direct connection, to at least one mobile computer 106 via a wireless connection or a direct connection, and to at least one cellular phone or mobile device 110, the cellular phones and mobile devices being configured to receive streaming video, internet-based content or Wireless Application Protocol (WAP) based content. The at least one computer 108 may also be stations or computers equipped with sensors and microphones positioned throughout a retail store, as discussed above, to be used as HIPA virtual stations. The at least one cellular phone and mobile device 110 can comprise, for example, cell phones, smart phones, PDAs, blackberries, iPhones, and so on and so forth.

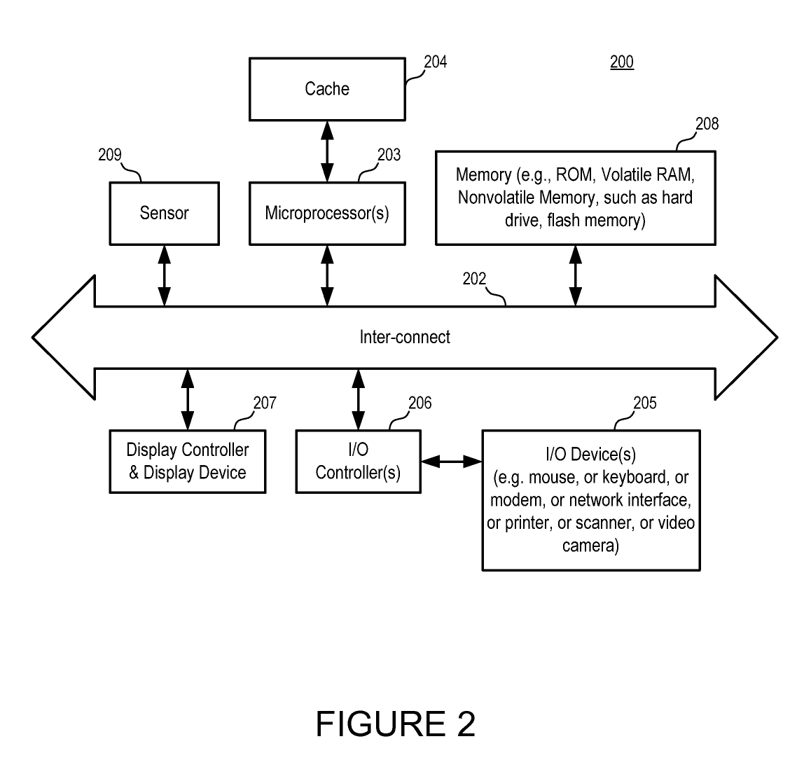

FIG. 2 shows an example user terminal used for a human intelligence personal assistance system according to one embodiment. While FIG. 2 illustrates various components of a computer system, it is not intended to represent any particular architecture or manner of interconnecting the components. Some embodiments may use other systems that have fewer or more components than those shown in FIG. 2.

In FIG. 2, the data processing system 200 of an user terminal includes an inter-connect 202 (e.g., bus and system core logic), which interconnects a microprocessor(s) 203 and memory 208. The microprocessor 203 is coupled to cache memory 204 in the example of FIG. 2.

The inter-connect 202 interconnects the microprocessor(s) 203 and the memory 208 together and also interconnects them to a display controller, display device 207, the sensor 209 and to peripheral devices such as input/output (I/O) devices 205 through an input/output controller(s) 206.

The sensor 209 may include, for example, an accelerometer to determine the orientation of the user terminal and/or to detect the shaking of the user terminal, or as another example, audio recording equipment to record sound near the user terminal.

Typical I/O devices include mice, keyboards, modems, network interfaces, printers, scanners, video cameras, touch pads, microphones and other devices which are well known in the art. In some embodiments, when the data processing system is a server system, some of the I/O devices, such as printer, scanner, mice, and/or keyboards, are optional.

The inter-connect 202 may include one or more buses connected to one another through various bridges, controllers and/or adapters. In one embodiment the I/O controller 206 includes a USB (Universal Serial Bus) adapter for controlling USB peripherals, and/or an IEEE-1394 bus adapter for controlling IEEE-1394 peripherals.

The memory 208 may include ROM (Read Only Memory), volatile RAM (Random Access Memory), and non-volatile memory, such as hard drive, flash memory, etc.

In the foregoing specification and the following appended documents, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

In this description, various functions and operations may be described as being performed by or caused by software code to simplify description. However, those skilled in the art will recognize that what is meant by such expressions is that the functions result from execution of the code/instructions by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

A machine readable medium also can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory. The non-volatile memory can be a local device coupled directly to the rest of the components in the data processing system. A non-volatile memory that is remote from the system, such as a network storage device coupled to the data processing system through a network interface such as a modem or Ethernet interface, can also be used.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

The computer-readable media may store the instructions. In general, a tangible machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

The disclosure includes methods and apparatuses which perform these methods, including data processing systems which perform these methods, and computer readable media containing instructions which when executed on data processing systems cause the systems to perform these methods.

While the methods and systems have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

In this regard it should be understood that for practical reasons and so as to avoid adding potentially hundreds of claims, the applicant has presented claims with initial dependencies only.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive forms so as to afford the applicant the broadest coverage legally permissible in accordance with the following claims.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer-implemented method for human intelligence personal assistance, comprising:
presenting a moving video image to a user;
receiving, via a computing device, an input from the user requesting an execution of at least one task;
determining whether the execution should be performed by zero or more operators in conjunction with zero or more computers wherein there is at least one operator or at least one computer;
performing, via a finding of the determining, the execution producing results; and
outputting to the user the results wherein the results are conveyed to the user in synchronization with the moving video image.

2. The computer-implemented method of claim 1, wherein the performing the at least one task comprises:
breaking down the at least one task into at least one piece for an implementation;
concluding whether the implementation should be performed by zero or more operators in conjunction with zero or more computers wherein there is at least one operator or at least one computer;
performing, via a decision of the concluding, the implementation; and
re-joining an outcome of the performing the implementation back into the results.

3. The computer-implemented method of claim 1, wherein the moving video image is an image of a human, the results comprise audio output, and the synchronization comprises synchronization of the audio output with a lip movement of the image of the human.

4. The computer-implemented method of claim 1, wherein the moving video image is computer generated.

5. The computer-implemented method of claim 1, wherein the input comprises at least one selected from the group consisting of motion detection, voice, video, keyboard, touchscreen, mouse, and stylus.

6. The computer-implemented method of claim 1, wherein the one or more computers are networked with zero or more additional computers.

7. The computer-implemented method of claim 1, wherein the one or more computers are in communication with a server.

8. The computer-implemented method of claim 1, wherein the performing comprises generating one or more of the group consisting of voice to text, text to voice, text to text, voice to voice, video to video, translation of the input, translation of the results, computer to computer text, computer to computer voice, and computer to computer video.

9. The computer-implemented method of claim 1, wherein the computing device performs at least one of parsing the input and filtering the input.

10. A computer-implemented human intelligence personal assistance system, comprising:
a display configured to present a moving video image to a user,
a computing device configured to receive an input from the user requesting an execution of at least one task;
means for determining whether the execution should be performed by zero or more operators in conjunction with zero or more computers wherein there is at least one operator or at least one computer;
means for performing, via a finding of the determining, the execution producing results; and
means for outputting to the user the results wherein the results are conveyed to the user in synchronization with the moving video image.

11. The computer-implemented system of claim 10, wherein the means for performing the at least one task comprises:
means for breaking down the at least one task into at least one piece for an implementation;
means for concluding whether the implementation should be performed by zero or more operators in conjunction with zero or more computers wherein there is at least one operator or at least one computer;
means for performing, via a decision of the concluding, the implementation; and
means for re-joining an outcome of the performing the implementation back into the results.

12. The computer-implemented system of claim 10, wherein the moving video image is an image of a human, the results comprise audio output, and the synchronization comprises synchronization of the audio output with a lip movement of the image of the human.

13. The computer-implemented system of claim 10, wherein the moving video image is computer generated.

14. The computer-implemented system of claim 10, wherein the input comprises at least one member selected from the group consisting of motion detection, voice, video, keyboard, touchscreen, mouse, and stylus.

15. The computer-implemented system of claim 10, wherein the one or more computers are networked with zero or more additional computers.

16. The computer-implemented system of claim 10, wherein the one or more computers are in communication with a server.

17. The computer-implemented system of claim 10, wherein the means for performing comprises means for generating one or more members of the group consisting of voice to text, text to voice, text to text, voice to voice, video to video, translation of the input, translation of the results, computer to computer text, computer to computer voice, and computer to computer video.

18. The computer-implemented system of claim 10, wherein the computing device is configured to perform at least one of parsing the input and filtering the input.
